(19) United States
(12) Patent Application Publication
(10) Pub. No.: US 2012/0152961 A1
(43) Pub. Date: Jun. 21, 2012

(54) PAINT PAN AND INTEGRATED UTENSIL CLEANER

(76) Inventors: Mike DiBlasi, Pleasant Valley, NY (US); Deb DiBlasi, Pleasant Valley, NY (US); Michael McGowan, LaGrangeville, NY (US)

(21) Appl. No.: 12/970,332

(22) Filed: Dec. 16, 2010

(51) Int. Cl. B05C 21/00; B44D 3/12

(52) U.S. Cl. 220/570; 15/257.06

(57) ABSTRACT

A paint pan and integrated paint utensil cleaner for the removal of excess paint from paint tools used in commercial and residential painting procedures. The paint tray and integrated cleaner includes a vessel for the retention of paint as well as a compression paint utensil cleaner. The compression based paint utensil cleaner compresses excess paint from the paint utensil and directs the excess paint back into the vessel for storage. The paint pan also includes two flanges or foot rests for securing the paint pan to a flat surface during the cleaning operation. A variety of diameters and configurations of paint pan can be accommodated by the proposed invention.

### BACKGROUND OF THE INVENTION

This invention relates to painting tools and apparatus and, more particularly, to deep seat paint pans and accessories for their practical use. The improved paint pan and utensil cleaner configured to provide for a utility enhancing construction and cleaning function that are integral to the physical body of the paint pan, and limits the need for external cleaning accessories. The paint pan is envisioned as a deep reservoir paint pan provided with physical dimensions of a standard paint pan. The envisioned improved paint pan paint and utensil cleaner incorporates an integral paint utensil cleaner designed to remove excess paint from paint rollers and covers used with paint pan pans. This can be accomplished by using the integral paint re paint pan to compress and strain excess paint from a paint roller or paint brush. The envisioned improved paint pan also incorporates stabilizing flanges that allow a user of the device to secure the pan to a surface with compressive force so as to effectuate the cleaning operation.

### PRIOR ART

It is currently known in the art to provide for paint pan configured for use with rollers or paint brushes. It is also known in the art to provide traditional paint scraping tools for removing paint from paint applicators.

For example, U.S. Pat. No. 4,205,411 to Cupp et al. discloses a paint tray having a well in one end; a ramp in an opposite end; the ramp having a wiping lip; and a pair of left and right passages extending downwardly from the wiping lip adjacent the left and right side walls. A roller is journaled in the well of the tray with a stub shaft extending axially beyond each roller face.

U.S. Pat. No 4,547,926 to Kern discloses a paint roller tray that has a closed bottom and sides which terminate in an upper periphery. The paint tray includes a cover and divisions for the securing of paint rollers.

U.S. Pat. No. 5,139,139 to Goetz discloses a paint tray for application of paint to tools used in fine detailing. The paint tray as described includes two troughs, one disposed on either side. Each trough is in fluid communication with a well in the opposite end of the tray. As such, the paint tray of Goetz provides for improved paint tray stability.

U.S. Pat. No. 7,083,044 Kilian et al describes a deep-seat paint tray having a cover with a lip positioned on the periphery of the side for engaging the lip of the deep-seat paint roller pan.

The deep-seat paint roller pan has a depth on the shallow end exceeding the diameter of the paint roller handle. This configuration provides a means for positioning a paint roller within the tray prior to sealing the cover to the tray.

In each of these prior art references, the paint pans and covers provided fail to solve the problem of excess paint of a roller. What is needed is a paint pan that provides a painter with the ability to clean the paint applicator at the work-site with minimal use of water or solvents. Furthermore, what is needed is an integrated solution that allows for less paint to be used in the painting. Lastly, what is needed is a solution that allows for the entire paint cleaning process to involve the minimal amount of additional and expensive accessories and specialized hardware.

### SUMMARY OF THE INVENTION

The present invention is a deep-seat paint pan and paint applicator cleaning apparatus designed and configured to recover excess paint from a standard paint roller and cover.

The deep-seat pan is configured to include a paint pan tray made formed of resilient or plastic materials. The envisioned apparatus has elongated walls joined to form a deep pan and reservoir for paint. The envisioned apparatus is configured with a utensil cleaner apparatus configured as an opening located within one of the walls of the paint pan. This configured opening is delineated by circular or semicircular geometry with a diameter that is appropriate to permit passage of a paint roller. The opening can be configured to taper as it travels through wall, resulting in steadily decreasing diameter. Additionally, the smaller diameter opening can be located at a lower position relative to the larger diameter opening. Additionally, the material body of the pan is formed such that the utensil cleaner apparatus is integral to the paint pan, and is not formed of a separate piece. The configured opening is provided and designed so that usage is limited to one direction and to limit the amount of paint that might be spilt on the outside the pan. The notch is further configured to have an integral spout or depression that allows for the paint to flow unobstructed into the reservoir of the paint pan. The cleaning apparatus can be located on either the front or back portion of the paint tray. Conversely, a stability mechanism is located on the opposite side of the paint tray as the cleaning utensil.

The material body of the paint pan is configured to have material extensions that aid in the stability of the paint pan during cleaning procedures. Specifically, tabs of the resilient material extend outward from the paint pan. These tabs can be used to secure the paint pan with a heavy object, including the foot of an individual, while the paint roller is being cleaned.

The present invention solves the problems and overcomes the drawbacks and deficiencies of prior art paint pans by providing a paint pan with a integrated utensil cleaning apparatus configured to remove excess paint from a paint roller and cover. This function is accomplished with use of a material design that provides compressive force to the paint utensil that forces excess paint into the opening and is in turn channeled back into the paint pan. Through this apparatus, a user is able to easily insert a standard paint roller and cover into the larger diameter opening and push the brush through the scraper apparatus to achieve a clean paint utensil after painting.

Additionally, the present invention achieves its tasks by providing an integral force restriction mechanism. Integral to the sides and bottom of the provided paint pan, integral flanges extend and allow a user to place a heavy object to restrict the movement of the pan during the scraping process.

The present invention also overcomes the shortcomings of the prior art by providing a deep-seat paint roller pan with roller cleaner. The primary object of the present invention is to provide a paint roller cleaning apparatus designed to remove excess paint from a roller and deposit it within the deep-seat paint pan. Through the integrated compressive paint cleaner apparatus, a paint pan is provided that can more efficiently remove excess paint and other extraneous material prior to use or storage.

The proposed invention is more environmentally and fiscally sustainable since it lowers the volume of paint wasted in the painting process and limits the amount necessity for single use paint roller covers.

Another object of the present invention is to provide a paint roller apparatus that will scrape excess paint and particulate matter off of a paint roller cover prior to chemical or water washing.

Yet another object of the present invention is to provide a stable platform for cleaning or scraping the paint roller. Additional objects of the invention will become apparent as the description of the present invention is detailed. The present invention overcomes the shortcomings of the prior art by providing a deep-seat paint pan and integrated cleaning apparatus.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

The foregoing and other objects and advantages of the present invention will be apparent from the description to follow. Additional features, advantages, and embodiments of the invention may be set forth or apparent from consideration of the following detailed description, drawings, and claims. It is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a perspective view of the paint pan and integral utensil cleaner with the provided roller notch and integral stabilizer flanges according to the present invention formed and formed of a continuous piece of material;

FIG. 2 is a sectional view of the paint pan and integral utensil cleaner;

FIG. 3 is a front view of the paint pan and integrated utensil cleaner according to the present invention in which the notch stabilizer flanges are visible and shown to be integral to the pan;

FIG. 4 is an isometric view of the notched portion of the paint pan and roller tool in which the diameter of the first opening and the second opening are different;

FIG. 5A is a sectional view of an alternative embodiment of the paint pan and integrated utensil cleaner wherein the diameter of the opening in one face of the paint pan is larger than the corresponding diameter.

FIG. 5B is a section view of an alternative embodiment of the paint pan and integrated utensil cleaner wherein the paint roller is depicted and its proposed method of operation is indicated.

FIG. 6. is a front view of an alternate embodiment of the paint pan and integrated utensil cleaner wherein the utensil cleaner is located significantly within the body of the wall of the paint pan.

FIG. 7. is a top view of the secondary cleaner apparatus.

### DETAILED DESCRIPTION OF THE PREFERRED EMBODIMENT

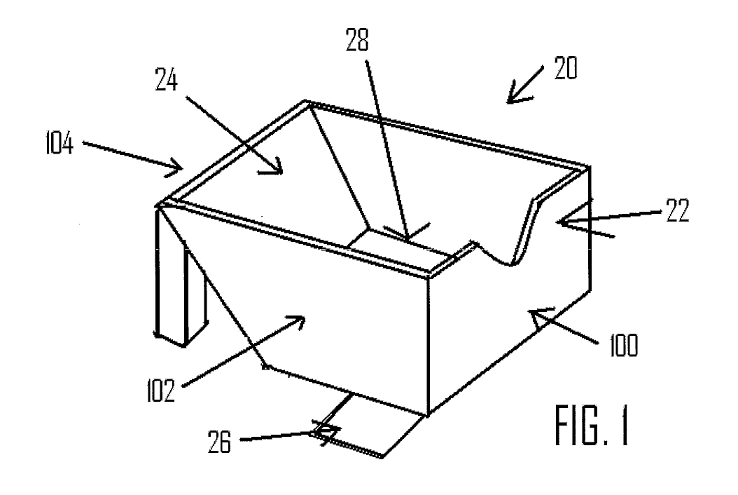

Referring now to the drawings wherein like references numerals designate corresponding parts throughout several views, FIGS. 1-7 illustrate a paint pan having an integrated utensil cleaner according to the present invention.

Specifically shown in FIG. 1, is a paint pan 20 with integral cleaner 22. The tray has an optional ramp 24 for the application of paint to rollers. The tray also has two flanges 26 to provide stability to the tray by evenly distributing paint weight. The paint pan further has a well or trough 28 for the collection of excess paint.

The tray 20 includes two side walls 102, a front wall 100 and a rear wall 104, as well as a bottom wall 28 that defines the interior volume of the tray. The ramp 24 extends from the front wall 100 and gradually declines toward the rear wall 104 and the bottom wall 28. The paint pan 20 is itself constructed of any high impact plastic or other resilient material. Specifically, it is envisioned that the paint pan be formed by injection molding press or other type of single integral construction methods. For example the paint pan 20 may be formed out of single piece of high-impact plastic sheeting. Alternatively, the paint pan 20 can be formed out metal or synthetic materials such as tin, aluminum, steel, iron, carbon fiber, plastic or synthetic plasticized fibers. Additionally, the paint pan provided in FIG. 1 is illustrative of the general proportions of a preferred embodiment of the present invention, but does not limit the dimensions of the invention described herein. The invention as envisioned, is not limited to any particular shape or form, baring those necessary to provide the functionality recited herein. The integral utensil cleaning apparatus 22 is located within the front wall 100 of the paint pan 20.

Depending on the preferred shape of the apparatus, the integral utensil is located in an upper portion and central portion of the front wall 100. The location of the utensil cleaning apparatus is in no way limited to the positions depicted in any of the foregoing figures.

It is further envisioned that the paint pan 20 has integrated flanges 26 in communication with the bottom wall, rear wall 104 or front wall 100 of the paint pan. The flanges depicted in FIG. 1 are in communication with the front wall 100 of the paint pan. The flanges 26 can be formed as a single continuous structure with a single material body coextensive with the bottom wall. In the alternative, the flanges can be constructed as separate material pieces and secured or fastened as attachments adhered to any of the prescribed walls of the paint pan 20.

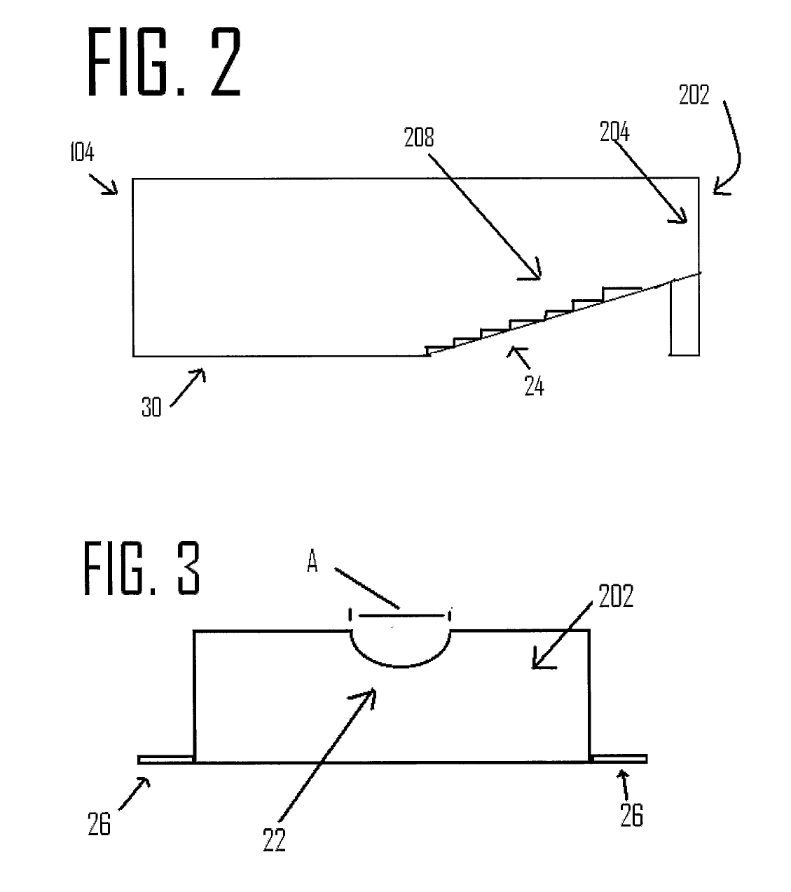

Referring to FIG. 2, the improved paint pan with integral cleaning utensil has a substantially rectangular shape defining the interior volume. The front wall 100 has an exterior face 202 and an interior face 204. The interior face 204 is directed towards the rear wall 104 and is optionally physically connected to the ramp 24 and the side walls 102. As further shown in FIG. 2, the ramp 24 can optionally posses a plurality of corrugated ribs 208. The ribs 208 are integrally molded in the structure of the ramp 24. Those skilled in the art would readily understand that the ribs 208 can be integrally molded into the ramp material or formed by another mechanism that allows for attachment of ribs 208 to the surface of the ramp 24.

The corrugated ribs 208 provide a further advantage for applying paint to rollers. By rolling the paint rollers along the incline and corrugated ribs 208, paint is evenly distributed along the application surface of the paint pan. Applying paint to the paint roller involves using the corrugated ribs 208 to temporarily retain excess paint on the ramp so that subsequent passes up and down the ramp with the paint roller will facilitate paint loading without the need for dipping the paint roller back into the reservoir.

The interior of the pan 20 has a reservoir 30 that allows excess paint to drain off the ramp 24 and become collected within the reservoir 30. The reservoir 30 is formed by the enclosed volume of the bottom wall 28, the back wall 104 and the ramp 24. The reservoir of the paint pan is configured to be the width of the entire paint pan 20. The reservoir 30 is suitable in shape and configuration for containing a sufficient amount of paint necessary to apply to a paint roller or brush. Furthermore, the reservoir 30 is configured to accommodate a paint roller pan or brush inserted and submerged completely within the reservoir 30.

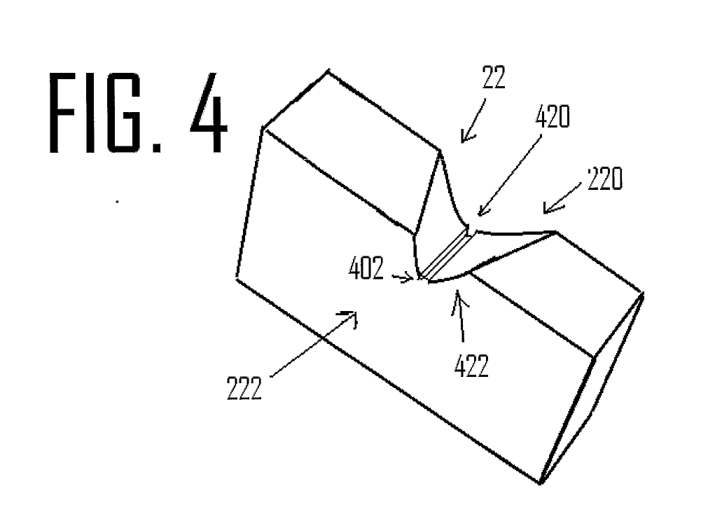

As seen on FIG. 3, the front face 202 of the paint pan 20 has an integral cleaner 22 introduced into the front wall 100. This integral cleaner 22 is formed as a passage between the inner face and the outer face, through the material of the front wall 100. The dimensions of the passage include the thickness of the wall material. The specific dimensions of the opening and passage through the wall material operates as an integral utensil cleaning apparatus of the improved paint pan. The integral utensil cleaning apparatus 22 provides means for scraping excess paint from the roller by means of a variety of integral internal mechanisms. In a preferred embodiment of the paint pan 20 described, the outer face 202 of the front wall 100 has the integral cleaner 22 positioned at the top part of the front wall 100. In an embodiment of the present invention, the integral cleaner 22 is a semi-circular shaped opening passing through the width of the wall material with an opening both in the interior face and exterior face of the front wall. FIG. 3 depicts the width (A) of the opening as being equal to the diameter of a virtual circle bisected by the top edge of the front wall. Furthermore, the depth of the integral cleaner is equal to the radii of that virtual circle. In the preferred embodiment, the integral cleaner 22 is situated at the top of the front wall and the depth of integral cleaner extends into the body of the front wall. It is conceived that the width A is suitably sized so as to accommodate a painting utensil. In the preferred embodiment, as seen in FIG. 3, the dimensions of integral cleaner 22 are configured to allow a paint roller frame and cover to be inserted into the depression. In a further embodiment, the integral cleaner 22 width A and its corresponding radii, are configured to be smaller than the diameter of a paint roller frame with a paint application cover installed. In this configuration, the edges of the paint pan delineating the integral cleaner perform like scrapers that force out excessive paint when the roller and applicator are inserted through the integral cleaner 22. For example, a paint roller can be cleaned of paint by use of this apparatus by repeatedly scraping a paint filled portion of the roller pan cover or frame along the opening formed in the wall by the integral cleaner 22. Optionally, a lip (not shown) can be coextensively formed of the same resilient material as the wall, and therefore be included as a portion of the integral cleaner. This lip would serve as an additional cleaning surface and provide further leverage while scraping the material.

As further seen in FIG. 3, the stability of the device is improved by inclusion of extendable flanges 26 along the lower portion of the paint tray 20. The flanges 26 are configured so that they extended beyond the footprint of the bottom wall 28 of the pan 20. The flanges are configured to be integral to the bottom of the paint pan, and to act as stabilizers to prevent overturning of the paint pan. Additionally, but not shown, the flanges have a top and bottom surface. Both surfaces are configured to prevent the arrest movement of the pan relative to the surface the pan is placed upon. The bottom surface possesses movement arresting textures to prevent movement against slippage or movement. Additionally, the top surface also incorporates arresting textures to present a surface configured to restrict the motion of a stabilizing weight that may be placed upon the flanges.

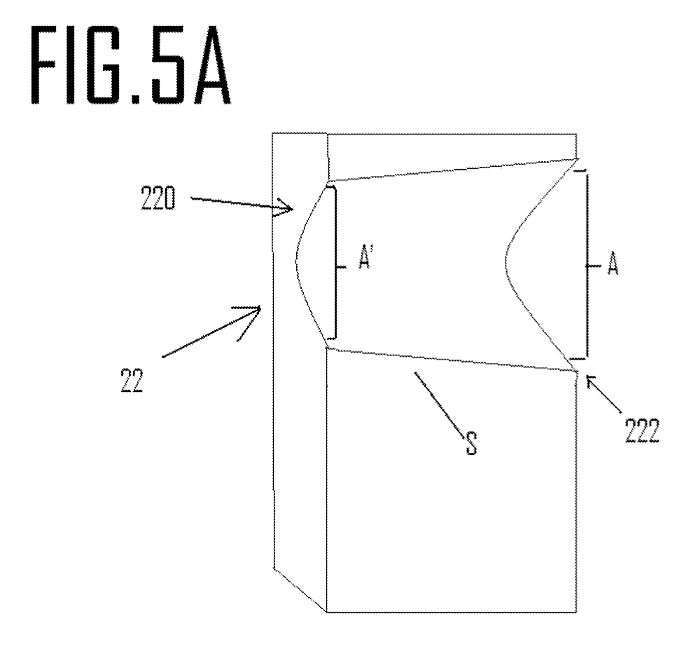

As seen in FIG. 4, an alternate embodiment of the present invention is envisioned. In the illustrated embodiment, for clarity purposes only, the utensil cleaning apparatus 22 is depicted without the remainder of the included elements. In the alternate embodiment of the integral cleaner 22, the inner face 220 of the front wall posses an inner face opening 420 that is larger than the paint roller frame. Furthermore, in this embodiment, it is important to note that the width A and the corresponding depth do not have a correlative relationship. The width A of the opening in the depicted embodiment is not the diameter of an imagined circle, while the depth of the opening is not the corresponding radii of said same virtual circle. In this embodiment, the integral cleaner opening has a geometry that is more angular and provides steeper sides to the utensil cleaning apparatus. Furthermore, as illustrated in FIG. 4, the outer face opening 422 of the integral cleaner is of a reduced size relative to the inner face opening 420. As a result of this configuration, the dimensions of the material depression decrease towards the outer face 220 of the front wall. As such, the material between the inner and outer openings has an introduced slope when viewed via cross section. It is envisioned that a paint roller and its attached cover, would be inserted into the integral paint cleaner 22 through the inner face opening 420. In this configuration, paint, once it has been compressed out of the painting utensil will flow towards the interior of the paint pan. Additionally, an optional channel 402 can be situated within the body of the utensil cleaning apparatus. Furthermore, a part of the inner face depression closest to the bottom wall optionally posses an angled notch (not shown). The angled notch is designed to direct excess paint onto the ramp with minimal clogging of the paint.

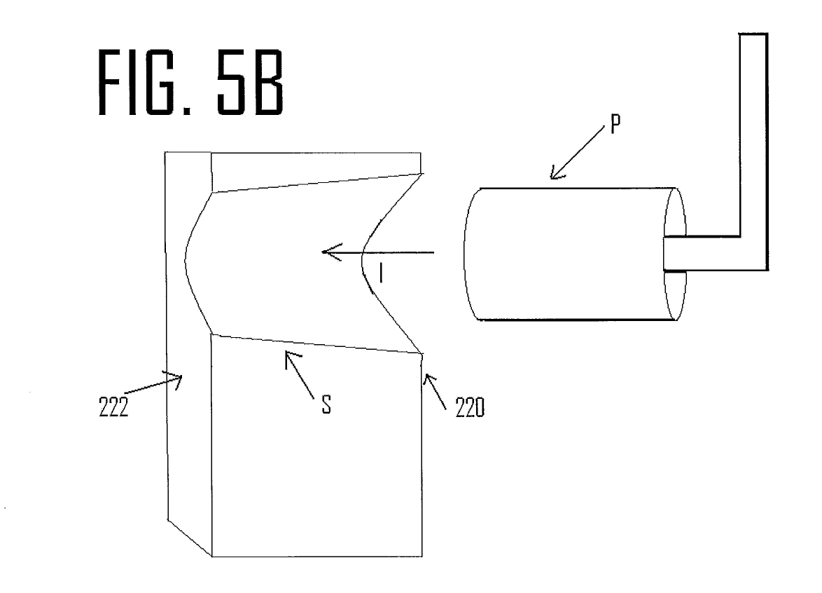

FIG. 5A provides a cross-sectional view of the integral cleaning apparatus 22. As shown in FIG. 5A, the inner face opening diameter A, is larger than the outer face diameter A′. Additionally, as depicted in FIG. 5A, the decrease in diameter between the openings provides for a slope (S) that becomes inherent in the integral cleaning apparatus 22. This slope S, allows for the natural draining of excess paint both prior and during the cleaning procedure. It is further envisioned that the diameter of the outer face could be smaller than the paint roller diameter. In this embodiment, as shown in FIG. 5B, the front wall is composed out of flexibly deformable material. Upon insertion of a paint roller P along line I, the outer face opening 222 will dilate under pressure and deformably expand to accommodate the proximate dimensions of the paint roller. Due to the natural resiliency of the material used, the outer face opening will exert compressive pressure on the paint roller as it is forced through. This compressive force will extract paint from the paint roller and the slope S will ensure that the extracted paint remains inside the paint pan 22. In this proposed embodiment, the inner face opening has a diameter that is larger than a paint roller with attached cover. However the outer face opening has a diameter that is less that of the roller frame and cover. As a result, during the cleaning procedure, sufficient force is necessary to insert the roller frame and cover though the small diameter opening. Due to the resiliency and malleability of the material, it is envisioned that the outer opening will dilate the outer face opening under sufficient force. In this way, the envisioned roller paint pan can accommodate several different diameter paint roller tools with a single paint roller pan. It is also envisioned that a plurality of openings could be placed in any reasonable arrangement in the front wall. In this way, multiple roller tools could be accommodated by a single pan.

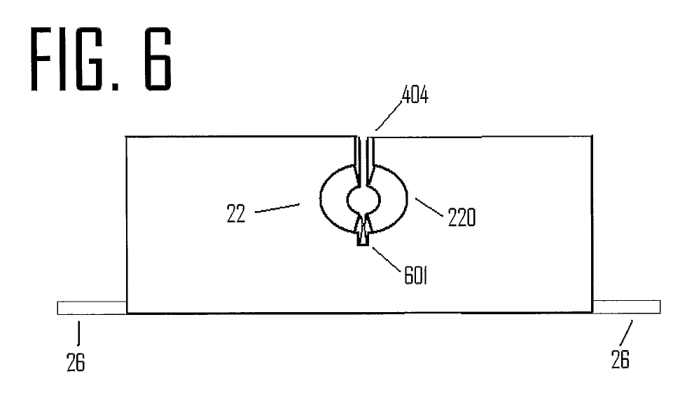

As seen in FIG. 6, in a still further embodiment of the paint pan and integral cleaning apparatus 22 described, the angled notch (601) can extend from the inner face to through the width of the front wall and to a position prior to the outer face of the front wall. In this way, the angled notch can collect excess paint from the entire apparatus and direct it towards the ramp. It is further envisioned that position of the openings on the front face 220 are positioned within the body of the front wall. Through this arrangement, it is further foreseen that the diameter of the outer face opening 222 is still smaller than the diameter of the inner space opening 220.

As seen in FIG. 6, the embodiment provides the inner and outer openings have been located substantially within the inner and outer faces of the front wall. Through this configuration, the top portion of the front wall posses only a guide channel 404 for the handle of the paint roller as opposed to a larger diameter opening. The handle channel 404 is designed to allow a user to guide the paint pan roller and/or cover completely through the apparatus. In the depicted embodiment, a substantial portion of the circumference of the paint pan frame and/or cover can be scraped and compressed by the integral cleaning apparatus 22.

While it is foreseen that the illustrated embodiments provide for the most efficient formation and usage of an integral cleaning apparatus, it is envisioned that still further embodiments could be provided depending on particular materials and uses. In a still further embodiment, it is envisioned that the paint cleaning apparatus posses an outer and inner face opening diameter that are of equal size.

Referring to FIG. 6, a user operates the apparatus by inserting a paint roller with a used paint roller cover into the depression in into the inner face of the front wall. The user can then optionally secure the pan to a surface by the application of weights or force. It is envisioned that tool boxes, weighted bags and the operator's hands and feet may be employed as a weighting mechanism. Once the paint pan is sufficiently secured, the cleaning operation can be initiated. The user forces the paint roller frame and/or cover through the openings disposed in the faces of the front wall. Through the compressive action of the constricted narrowing opening, paint is forced out of the paint roller cover and/or frame. The excess paint is directed by the sloping material depression and angled notch and is optionally channeled so as to ensure that the paint is funneled on the ramp. Furthermore, the present invention accomplished this without encountering the resistance of paint already forced out of the paint roller.

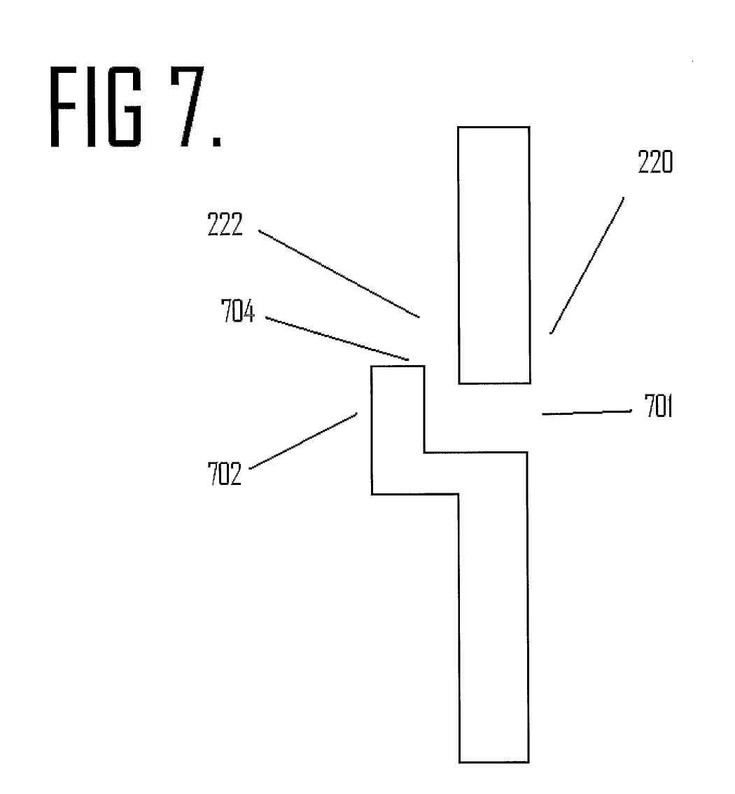

With regards to FIG. 7, it is optionally envisioned that the paint pan may incorporate a smaller opening providing the means of cleaning standard paint brushes. In this embodiment, a secondary vertical opening 701 is located any of the outer and inner faces of the front, side or rear walls. The opening is covered by a flap 702 of material coextensive with the structural material of the paint pan. It is envisioned that the paint pan material is sufficiently resilient that when a standard dimensioned paint brush is inserted into the opening, the opening is plastically deformed to allow passage while the resilience of the sides 704 of the opening constrict the sides of the paint brush. Through this action, paint can also be removed from a paint brush. It is further envisioned that a flap of material is extended beyond one end of the opening to cover the opening. This flap is formed of the same material as the paint pan and is configured to be flexibly deformed by the applied pressure of the paint brush. When pressure is not applied, the flap acts as a suitable barrier to the leakage of paint from the vertical opening.

While the invention has been particularly shown and described with reference to preferred embodiments thereof, it will be understood by those skilled in the art that various changes in form and details may be made therein without departing from the spirit and scope of the invention.

We claim:

1. A paint tray and integrated utensil cleaning apparatus comprising:
a container having a plurality of walls configured to enclose a volume of liquid, wherein each wall has an inner face, an outer face, a top portion and bottom portion; and
at least one slot formed within at least one of the walls, the slot being configured to allow the passage of a paint application utensil through the wall, wherein the slot is open along a top edge of the wall and is progressively narrower in a direction toward an outer face of the wall that the slot is formed in for cleaning the paint application utensil by passage of the paint application utensil through the slot.

2. The paint tray of claim 1, further including an angled channel formed in the wall at a bottommost location of the slot, the channel being angled downwardly into an interior of the container to direct the liquid to the interior.

3. The paint tray of claim 1, wherein the slot has a smooth, curved surface and is completely open along the top edge of the wall.

4. The paint tray of claim 1, further including at least two flanges extending outwardly from walls that are perpendicular to the wall of the container that includes at least one opening.

5. The paint tray of claim 1, wherein a widest portion of the slot is formed at a location that is spaced from the top edge of the wall and a first channel that is open at the top edge extends from the top edge to the widest portion of the slot, the first channel having a width that is less than the widest portion of the slot.

6. The paint tray of claim 5, further including an angled second channel formed at a bottommost portion of the slot for directing the liquid to the interior.

7. The paint tray of claim 6, wherein the second channel is angled downwardly from the outer face to the inner face.

8. The paint tray of claim 5, wherein the widest portion of the slot has a frusto-conical shape.

9. A painting supply kit comprising:
a paint application utensil that includes a roller that has an outer diameter;
a container having a plurality of walls configured to enclose a volume of liquid material and define an interior, wherein each wall has an inner face and an outer face; and
at least one slot formed within at least one of the walls and at least partially open along a top edge thereof, wherein a width of a portion of the slot is less than the outer diameter of the roller to permit cleaning of the roller when the roller passes from the interior through the slot.

10. The painting supply kit of claim 9, wherein the slot is open along a top edge of the wall and is progressively narrower in a direction toward an outer face of the wall that the slot is formed in for cleaning the paint application utensil by passage of the paint application utensil through the slot.

11. The painting supply kit of claim 9, wherein the slot comprises a V-shaped slot open along the top edge.

12. The painting supply kit of claim 9, wherein the slot comprises a semicircular-shaped slot open along the top edge.

13. A paint tray and integrated utensil cleaning apparatus comprising:
a container having a plurality of walls configured to enclose a volume of liquid, wherein each wall has an inner face, an outer face, a top portion and bottom portion;
at least one slot formed within at least one of the walls, the slot being configured to allow the passage of a paint application utensil through the wall, wherein the slot is open along a top edge of the wall and includes a lip along a perimeter of the slot at the inner face of the wall;
a channel formed in the wall within the slot and being angled to direct the liquid to the interior of the vessel; and
at least two flanges extending outwardly from walls that are perpendicular to the wall that includes at least one opening.

14. The paint tray of claim 12, wherein the flanges are configured to be secured to a surface by means of an external removable weight or force.

15. The paint tray of claim 12, wherein the slot is wider along the inner face relative to the outer face.

16. The paint tray according to claim 14, wherein a width of the slot at the outer face is less than a width of the paint application utensil.

17. The paint tray according to claim 12, wherein the slot at the inner face is positioned closer to a bottom wall relative to the slot at the outer face.

18. The paint tray according to claim 12, wherein the paint container further includes a ramp angled from a back wall to a front wall.

19. The paint tray according to claim 12, wherein an interior portion of the slot formed in the wall is equipped with a plurality of studs or nodules.
